(19) United States
(12) Patent Application Publication
(10) Pub. No.: US 2025/0348911 A1
(43) Pub. Date: Nov. 13, 2025

(54) SYSTEM AND METHOD FOR AUTOMATED DOMAIN ADVERTISING USING ARTIFICIAL INTELLIGENCE WITH LANGUAGE AND RETRIEVAL AUGMENTED MODELS

(71) Applicant: D3SERVE LABS INC, Sunnyvale, CA (US)

(72) Inventor: Zainan Zhou, Sunnyvale, CA (US)

(21) Appl. No.: 19/205,183

(22) Filed: May 12, 2025

Related U.S. Application Data
(60) Provisional application No. 63/645,908, filed on May 12, 2024.

(51) Int. Cl. G06Q 30/0241

(52) U.S. Cl. CPC G06Q 30/0277

(57) ABSTRACT

A system and method for automated domain advertising utilizing artificial intelligence is provided. The system includes a processor and memory in communication with the processor. The memory includes a user interface module, a domain advertising (DA) module, an artificial intelligence (AI) module, a posting module, and a domain parking module. The system receives the domain name from a user. The AI module generates the domain advertising suggestion based on the domain name. The domain advertising suggestion is provided to the user and may be posted to social media or a domain parking website. The AI module includes a large language model (LLM) and a retrieval-augmented generation (RAG) module. The RAG module includes a knowledge base to retrieve a knowledge-based response from an external knowledge source, an expert module to retrieve an expert response from a specialized domain model, and a ranker to rank the knowledge-based response and the expert response.

### CROSS-REFERENCE TO RELATED APPLICATIONS

This application claims the benefit of U.S. Provisional Application No. 63/645,908, filed on May 12, 2024. The entire disclosure of the above application is incorporated herein by reference.

### FIELD

The present technology relates to automated domain advertising using artificial intelligence with learning and retrieval augmented models. More specifically, ways of generating domain advertising suggestions based on user input and advertising the suggestions via domain parking website or social channel are provided.

### INTRODUCTION

This section provides background information related to the present disclosure which is not necessarily prior art.

In the fields of domain name advertising and marketing, certain operations are dependent on manual processes for generating advertising content. These manual approaches may require extensive human involvement to create appealing and contextually relevant advertising materials for domain names. The manual nature of these processes may lead to inefficiencies and inconsistencies, as well as time consumption. Additionally, manual approaches may not scale effectively in response to increasing demands for personalized and dynamic content. Other issues relate to the inability to automatically generate context-driven and engaging advertising content for domain names. For example, operations that produce generic or templated content may not capture the unique value proposition of specific domain names. These approaches may not effectively engage potential customers or convey the intended value proposition of the domain name. Inefficiency in generating targeted advertising content may lead to lost opportunities and reduced marketing effectiveness.

Despite advancements in digital marketing and artificial intelligence, many domain advertising systems employ techniques that may not implement emerging technologies such as artificial intelligence and machine learning. These systems may not adequately utilize language models or advanced retrieval techniques to generate applicable advertising materials that are aligned with brand messaging. Additionally, the generated content may not fully reflect the strategic objectives of marketing campaigns or resonate with diverse audience segments. One particular issue may arise from the limited integration capabilities inherent in some systems. Domain advertising platforms may not effectively connect with various communication channels or user interfaces. This lack of integration may restrict the ability to distribute advertising content seamlessly across multiple platforms, diminishing the reach and impact of marketing efforts. This manual synchronization of content across platforms may further introduce errors and inconsistencies. Other issues relate to caching efficiency, where the absence of an effective caching mechanism in certain advertising systems may lead to repeated processing of similar requests, causing unnecessary delays and resource consumption. Without optimizing storage and retrieval mechanisms, the overall system performance may degrade, impacting user experience and the timely dissemination of advertising content. Further issues relate to addressing the complexity of domain-specific advertising by incorporating relevant external knowledge sources or trained models in specific industry fields. The ability to retrieve and integrate domain-specific insights from various data sources may enhance the relevance and precision of generated advertising content. However, without such integration, the advertising suggestions may lack depth and fail to align with business trends or user demands.

There is a continuing need for improved ways for automating the generation of advertising suggestions using large language models and retrieval-augmented generation techniques. Desirably, these systems and methods would operate in a fashion that overcomes the limitations of manual processes by automating the generation of domain advertising suggestions using advanced technologies. Such systems and methods should effectively utilize language models and retrieval techniques to create high-quality, custom content. Moreover, improved integration capabilities, enhanced caching systems, and the incorporation of domain-specific knowledge may deliver more effective advertising solutions.

### SUMMARY

In concordance with the instant disclosure, improved methods and systems for automating the generation of advertising suggestions using large language models and retrieval-augmented generation techniques, have surprisingly been discovered.

The present technology includes systems and methods that relate to automated domain advertising by utilizing artificial intelligence, specifically large language models and retrieval-augmented generation techniques, to produce advertising suggestions for domain names with improved efficiency and contextual relevance. These techniques may enable the generation of high-quality advertising suggestions that maintain consistency and alignment with brand messaging. By integrating sophisticated caching mechanisms and modular architectures, the present technology may facilitate seamless interaction with various user interfaces and communication channels, enhancing the distribution and effectiveness of the advertising content. The incorporation of domain-specific insights and external knowledge may enhance the precision of the advertising content, addressing the limitations of manual methods and delivering more effective solutions in the domain name advertising and marketing sphere.

In certain embodiments, a system for generating a domain advertising suggestion to a user based on a domain name is provided. The system may include a processor and a memory in communication with the processor. The memory may include a user interface module, a domain advertising (DA) module, an artificial intelligence (AI) module, and a cache. The user interface module may receive the domain name from the user. The DA module may receive the domain name from the user interface module. The DA module may search the cache for the domain name and the domain advertising suggestion based on the domain name. The DA module may provide the user interface module the domain advertising suggestion based on the domain name when the cache includes the domain name. The AI module may receive the domain name from the DA module and generate the domain advertising suggestion based on the domain name. The AI module may provide the domain advertising suggestion to the DA module. The cache may receive the domain name from the user interface module and store the domain name. The cache may receive and store the domain advertising suggestion when generated by the AI module. The DA module may provide the user interface module the domain advertising suggestion based on the domain name when generated by the AI module.

In certain embodiments, a method for generating a domain advertising suggestion to a user based on a domain name is provided. The method may include a step of providing a processor, and a memory in communication with the processor. The memory may include a user interface module, a domain advertising (DA) module, an artificial intelligence (AI) module, and a cache. The user interface module may receive the domain name from the user. The DA module may receive the domain name from the user interface module. The DA module may search the cache for the domain name and the domain advertising suggestion based on the domain name. The DA module may provide the user interface module the domain advertising suggestion based on the domain name when the cache includes the domain name. The AI module may receive the domain name from the DA module and generate the domain advertising suggestion based on the domain name. The AI module may provide the domain advertising suggestion to the DA module. The cache may receive the domain name from the user interface module and store the domain name. The cache may receive and store the domain advertising suggestion when generated by the AI module. The DA module may provide the user interface module the domain advertising suggestion based on the domain name when generated by the AI module.

The method may include a step of receiving the domain name from the user via the user interface module. The method may include a step of receiving the domain name from the user interface module and storing the domain name in the cache. The method may include a step of searching the cache for the domain name and the domain advertising suggestion. The method may include a step of providing the user with the domain advertising suggestion based on the domain name when the cache includes the domain name. The method may include a step of generating a domain advertising suggestion via the AI module when the cache does not include the domain name, thereby producing a generated suggestion, the generated suggestion based on the domain name. The method may include a step of providing the user the generated suggestion via the user interface module when the cache does not include the domain name. The method may include a step of storing the domain name and the generated suggestion in the cache.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagram illustrating an embodiment of a system for generating a domain advertising suggestion to a user based on a domain name;

FIG. 2 is a sequence diagram illustrating an executing of a domain name request by a user to an artificial intelligence (AI) module;

FIG. 3 is a block diagram illustrating an embodiment of a chatbot;

FIG. 4 is a sequence diagram illustrating a multi-tiered caching arrangement for executing a domain name request by a user;

FIG. 5 is a block diagram illustrating a storing and a retrieval of a domain name suggestion from a cache and from a database;

FIG. 6 is a block diagram illustrating an executing of a domain name request by a user utilizing a retrieval-augmented generation (RAG) module;

FIGS. 7A, 7B, and 7C provide a sequence diagram illustrating the executing of a domain name request by a user utilizing the RAG module of FIG. 6;

FIG. 8 is a block diagram illustrating a phase-based schema for the executing of a domain name request by a user utilizing a RAG module;

FIG. 9 is a block diagram illustrating an embodiment of a posting module;

FIG. 10 is a block diagram illustrating an embodiment of a domain parking module;

FIG. 11 is a block diagram illustrating an embodiment of a domain name system (DNS) management module;

FIG. 12 is a block diagram illustrating an embodiment of a security module;

FIGS. 13A and 13B provide a flowchart illustrating an embodiment of a method for generating a domain advertising suggestion to a user based on a domain name;

FIG. 14 provides a flowchart extending from FIGS. 13A and 13B and further illustrates the method for generating a domain advertising suggestion to a user based on a domain name;

FIG. 15 provides a flowchart extending from FIGS. 13A and 13B and further illustrates the method for generating a domain advertising suggestion to a user based on a domain name;

FIG. 16 provides a flowchart extending from FIGS. 13A and 13B and further illustrates the method for generating a domain advertising suggestion to a user based on a domain name;

FIG. 17 provides a flowchart extending from FIGS. 13A and 13B and further illustrates the method for generating a domain advertising suggestion to a user based on a domain name; and

FIG. 18 provides a flowchart extending from FIGS. 13A and 13B and further illustrates the method for generating a domain advertising suggestion to a user based on a domain name.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of a steps presented is exemplary in nature, and thus, the order of a steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one clement or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

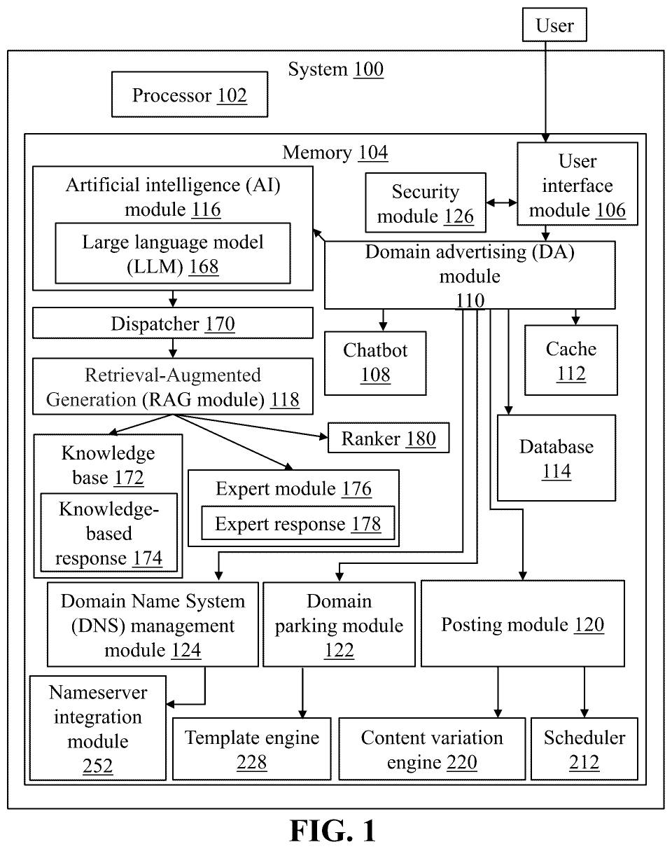

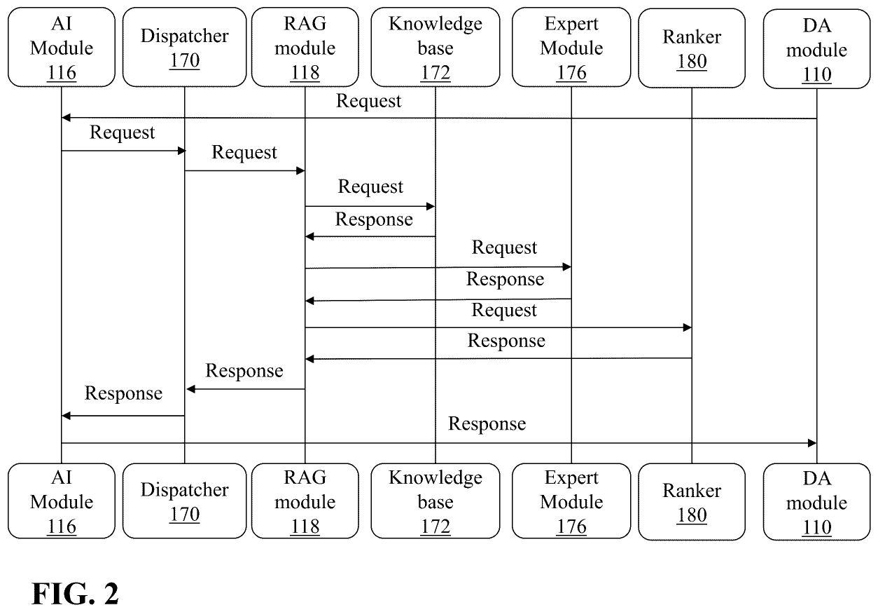

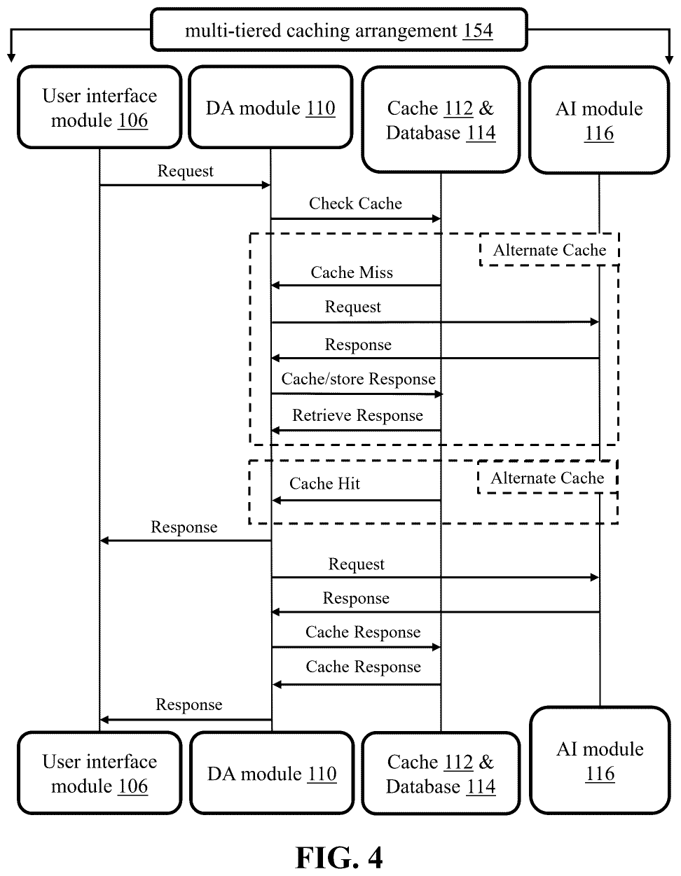

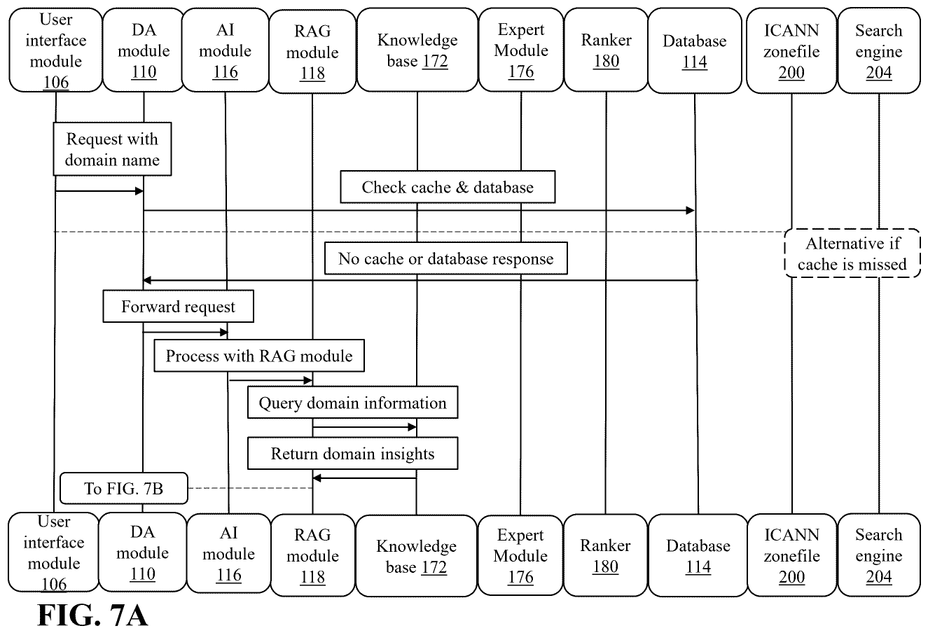

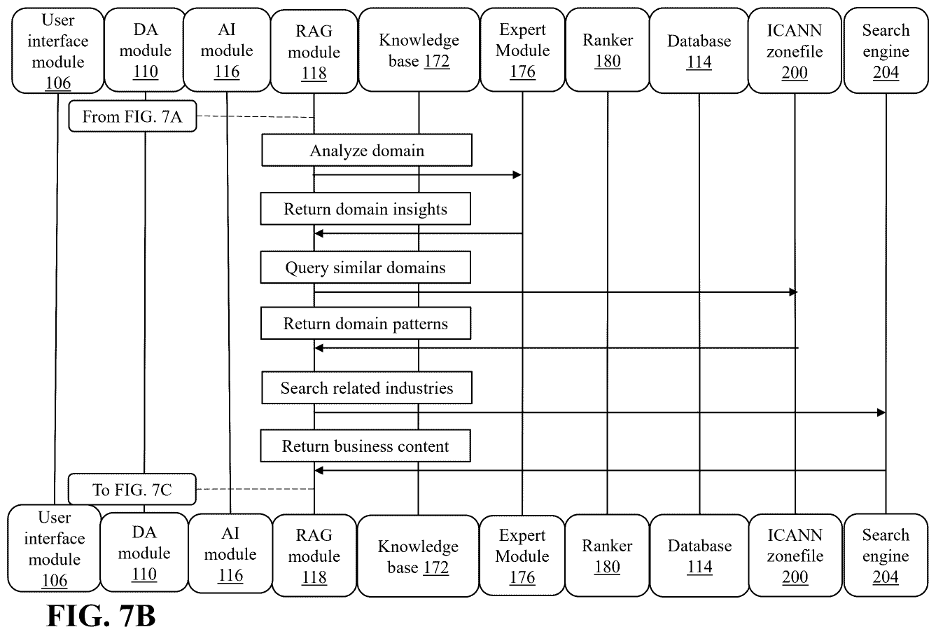

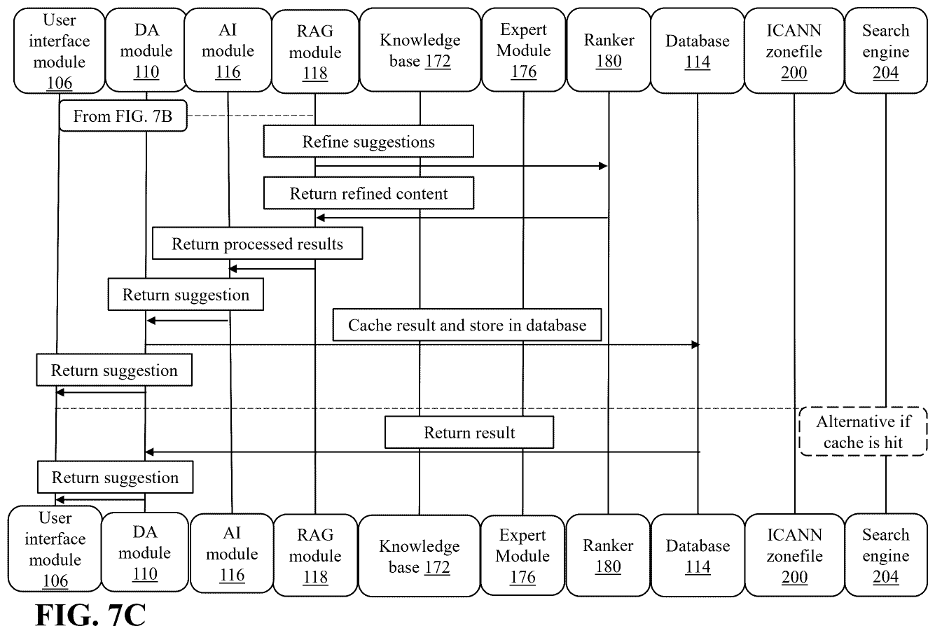

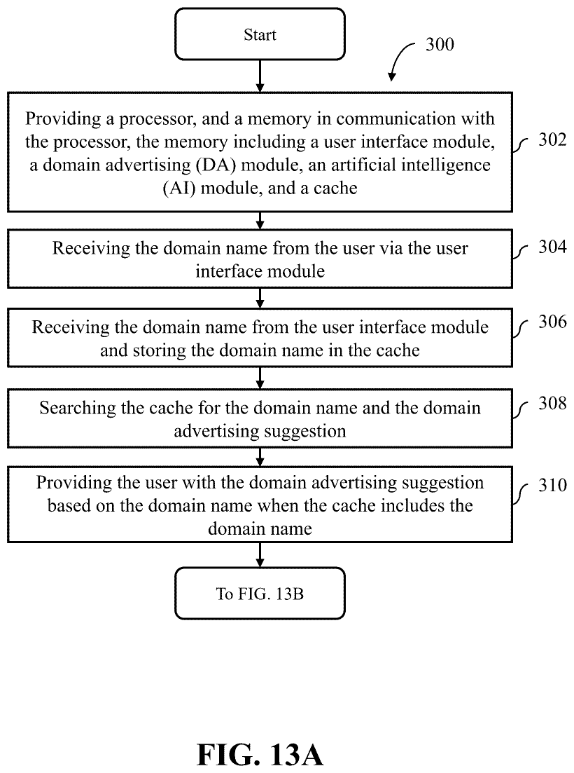

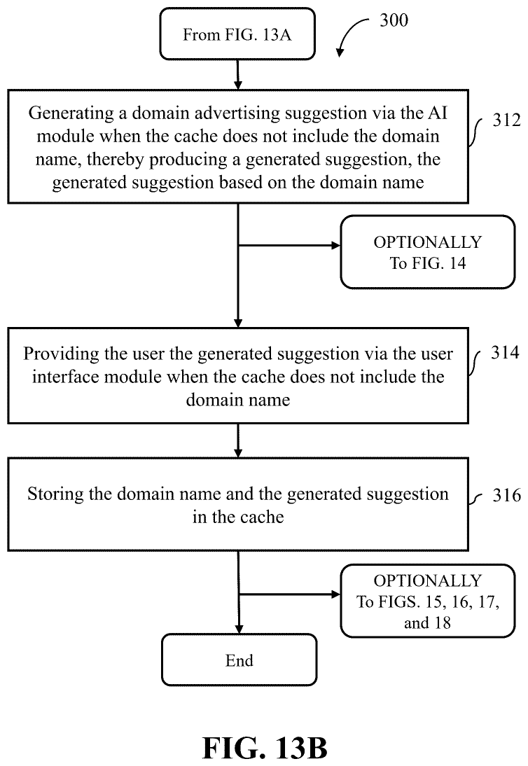

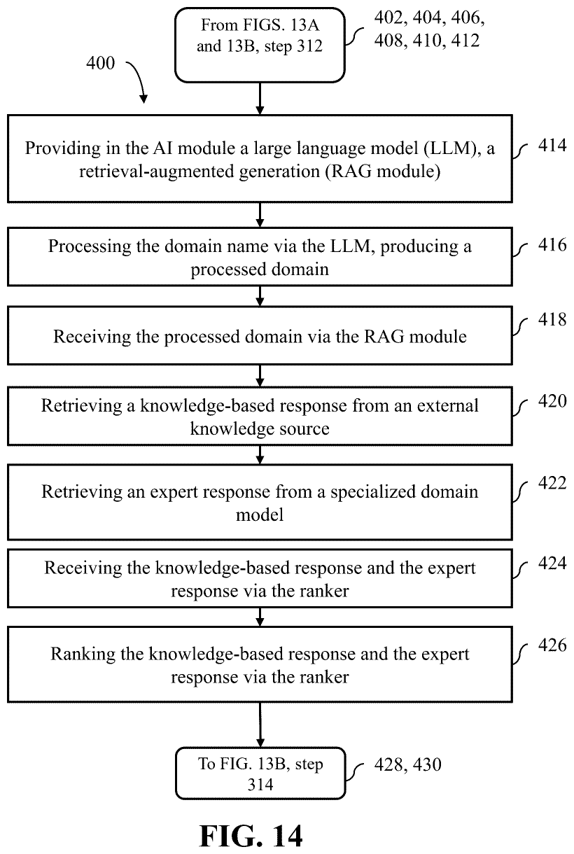

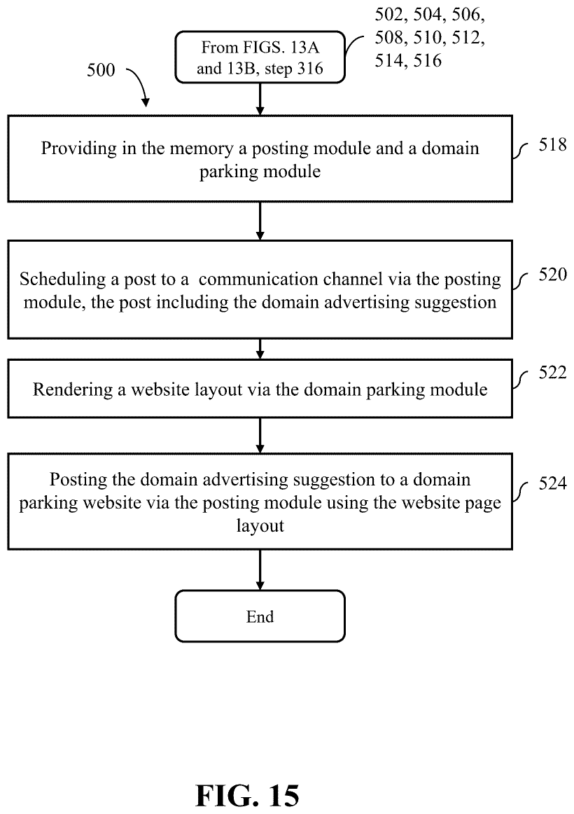

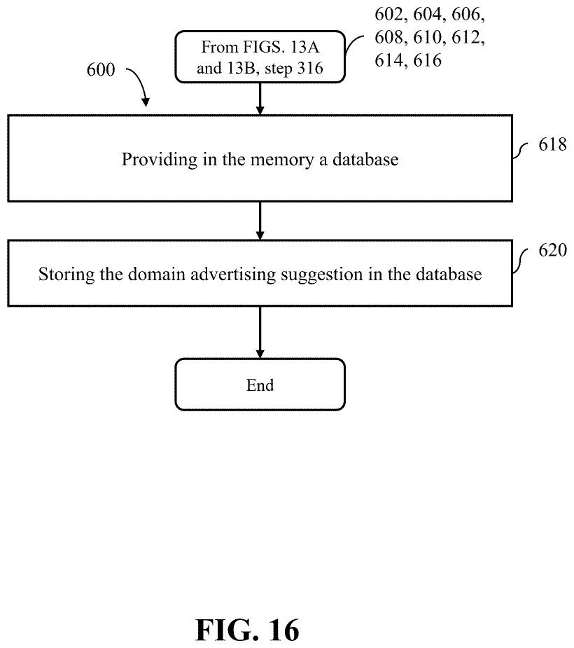

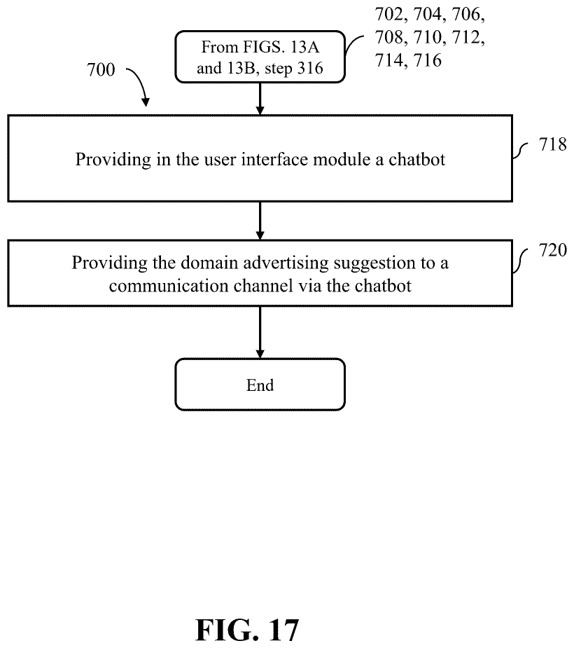

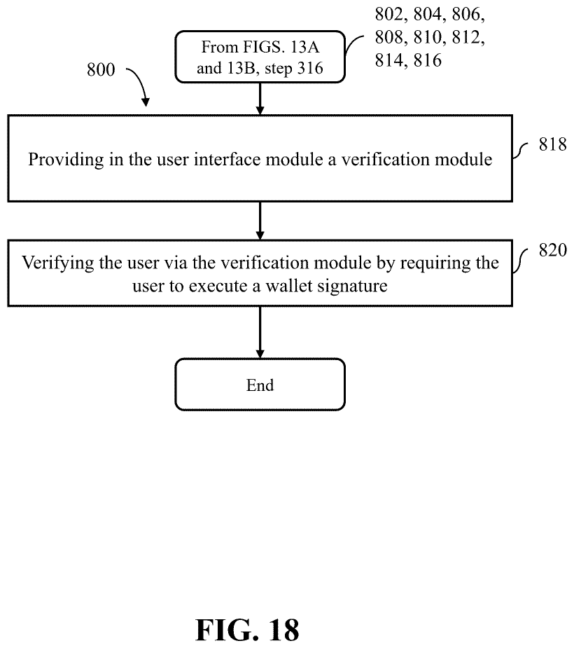

The present technology provides an advanced system for automating domain advertising by utilizing artificial intelligence, specifically language models and retrieval-augmented generation techniques, aspects of which are shown generally in accompanying FIGS. 1-12. A method 300 for automating domain advertising by utilizing artificial intelligence is also disclosed, aspects of which are shown in FIGS. 13A and 13B. Another method 400 for automating domain advertising by utilizing artificial intelligence is disclosed in FIG. 14. Another method 500 for automating domain advertising by utilizing artificial intelligence is disclosed in FIG. 15. And another method 600 for automating domain advertising by utilizing artificial intelligence is also disclosed in FIG. 16. Another method 700 for automating domain advertising by utilizing artificial intelligence is also disclosed in FIG. 17. And yet another method 800 for automating domain advertising by utilizing artificial intelligence is disclosed in FIG. 18.

The system 100 and methods 300, 400, 500, 600, 700, and 800 allow a user to produce advertising suggestions for domain names utilizing artificial intelligence and machine learning. As shown in FIGS. 1-12, the system 100 may include a processor 102 and a memory 104 in communication with the processor 102. The memory 104 may include a user interface module 106, a chatbot 108, a domain advertising (DA) module 110, a cache 112, a database 114, an artificial intelligence (AI) module 116, a retrieval-augmented generation (RAG) module 118, a posting module 120, a domain parking module 122, a domain name system (DNS) management module 124, and a security module 126. The DA module 110 may check the cache 112 for a domain name 128, and if the cache 112 includes a matching domain name 128, the DA module 110 may return a corresponding domain advertising suggestion 130 to the user. If the cache 112 does not include a matching domain name 128, the DA module 110 may send a request to the AI module 116 to generate a new domain advertising suggestion 130. The AI module 116 may send the request to the RAG module 118. The RAG module 118 may generate a domain advertising suggestion 130 and return the domain advertising suggestion 130 to the AI module 116. The AI module 116 may return the domain advertising suggestion 130 to the DA module 110 to be stored the response in the cache 112 or the database 114 or provided to the user via the user interface module 106.

The processor 102 may be located on a local system 100 or a remote system 100 server accessed via a network. The remote system 100 server may be the central hub of the system 100, containing the processor 102 and memory 104 that store and execute the modules necessary for processing input date. One skilled in the art will also appreciate that the processor 102 may include one or more processors 102 and may process information and executing instructions or operation. For example, the processor 102 may include a central processing unit (CPU), a microprocessor 102, a microcontroller, or a system-on-a-chip 100, a digital signal processor 102 (DSPs), field-programmable gate arrays (FPGAs), application-specific integrated circuits (ASICs), or processors 102 based on a multi-core processor 102 architecture. One or more processors 102 may mean a single processor 102 or multiple processors 102 in a single processing unit, e.g., a central processing unit, or multiple processing units, e.g., a central processing unit and a graphics processing unit, or a central processing unit and a memory 104 manager. The processor 102 may include multiple processors 102 where one processor 102 is capable of executing one or more of the elements described in this disclosure, and a subsequent processor 102 or processors 102 may execute other elements as described herein, capable of executing all elements only in combination. One or more of the processors 102 may be remote from the at least one system 100 server.

The memory 104 may store or otherwise include one or more databases 114. The memory 104 can include one or more memories 104 and of any type suitable to the local application environment and can be implemented using any suitable volatile or nonvolatile data storage technology such as a semiconductor-based memory 104 device, a magnetic memory 104 device and system 100, an optical memory 104 device and system 100, fixed memory 104, and removable memory 104. For example, the memory 104 may include any combination of random-access memory 104 (RAM), read only memory 104 (ROM), static storage such as a magnetic or optical disk, hard disk drive (HDD), or any other type of non-transitory machine or computer readable media.

Referring now to FIGS. 1, 4 and 7A-7C, the user interface module 106 may serve as an interface for the system 100. The user interface module 106 may serve as the point of interaction between a user and the system 100 and interact with hardware including various output devices that may display a representation of the user interface module 106 for observation by the user, where such an output device may include, for example, one or more computer screen, speaker, tablet screen, or other view/audio port, an input device such as a keyboard, microphone, and the like. The user interface module 106 may be accessible via a desktop application, smartphone or mobile application, web interface, API, or a text-based chatbot 108. The user interface module 106 may interface with mobile SMS, decentralized social platforms, email automation tools, or voice assistants. The user interface module 106 may be designed to be intuitive and user-friendly, for example, with custom user preferences and accessibility requirements, allowing the user to easily upload, type, or choose a retrieved or generated domain name 128 and receive a domain advertising suggestion 130. For example, the user interface module 106 may present and manage the textual and graphical display of a retrieved or generated domain advertising suggestion 130 via the chatbot 108. The user interface module 106 may collect the domain name 128 from the user for further processing and advertising suggestion generation by system 100, and for use in future domain name 128 inquiries.

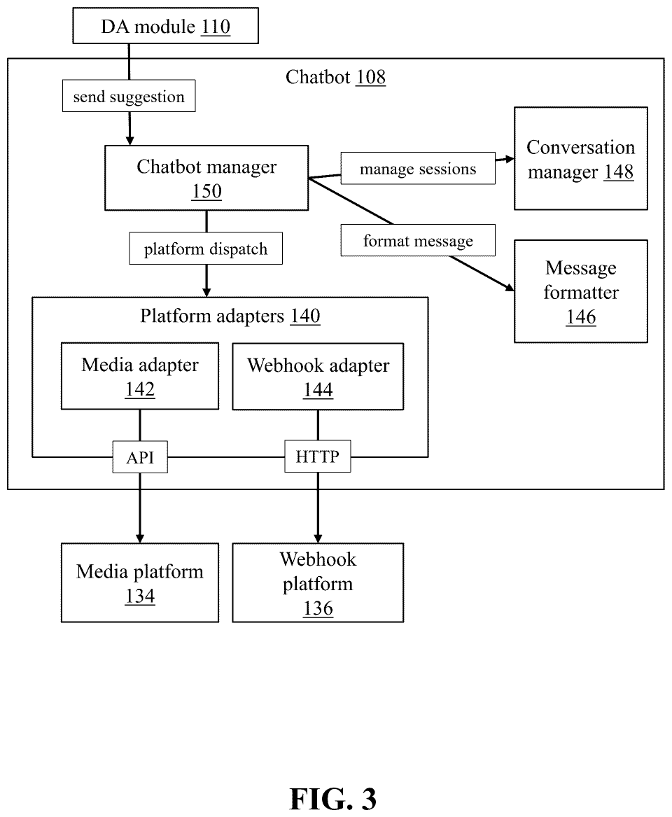

As shown in FIG. 3, the chatbot 108 may receive and generate a textual conversation with the user via the user interface module 106. The chatbot 108 may provide the domain advertising suggestion 130 to the user, as well as to a communication channel 132 (e.g., social platforms, messaging APIs, web integrations). The communication channel 132 may include a media platform 134, e.g. media platforms 134 by X™ (formerly Twitter®) or Discord®, team collaboration tools, e.g. collaboration tools by Slack®, or Microsoft Teams®, a webhook platform 136, e.g. Gitlab®, Shopify®, or Stripe®, a custom web interface, or a domain parking website 138. The chatbot 108 may automatically generate and post domain advertising suggestions 130 to a communication channel 132 where users of the communication channel 132 may interact with the chatbot 108 on the communication channel 132, including inquiring about the posted domain advertising suggestion 130. The chatbot 108 may be in communication with platform adapters 140 including a media adapter 142 and a webhook adapter 144. The media adapter 142 may provide dedicated integration for each supported media platform 134. The webhook adapter 144 may provide dedicated integration for each supported webhook platform 136. The chatbot 108 may include a message formatter 146 to ensure that the domain advertising suggestion 130 is optimized for each media platform 134 and each webhook platform 136. The chatbot 108 may include a conversation manager 148 to enforce a character limit for each post, allowing for efficient attachment handling and platform-specific markup. The chatbot 108 may utilize a chatbot manager 150 to receive a domain advertising suggestion 130 from the DA module 110 to manage sessions with the conversation manager 148, format messages for the message formatter 146, and dispatch the domain advertising suggestion 130 to the platform adapters 140. For example, the chatbot 108 may maintain context history across interactions, tracking each session or conversation to enhance context awareness for future responses. It should be appreciated that the distribution capabilities of the chatbot 108, including posting and communication on a communication channel 132, may allow for highly targeted domain advertising suggestions 130 to reach the most relevant potential buyers across platforms they already use for domain name 128 acquisition.

As shown in FIGS. 1, 4, and 7A-7C, the DA module 110 may manage the generating, storing, and retrieving of domain name 128 requests and domain advertising suggestions 130. For example, the DA module 110 may receive a domain name 128 from the user interface module 106 and facilitate the delivery of a domain advertising suggestion 130 to the user or to a communication channel 132. The DA module 110 may utilize the cache 112, implementing a multi-tiered caching arrangement 154 to improve the efficiency of generating and storing a domain advertising suggestion 130. When a domain name 128 request is received from the user interface module 106, the DA module may first search the cache 112. The cache 112 may store and retrieve a previously generated domain advertising suggestion 130. The system 100 may include an in-memory cache 152 for storing a recent domain advertising suggestion 130 and frequent domain name 128 requests. If the cache 112 is hit, or in other words, if a matching domain name 128 is found in the cache 112, the cache 112 may return the stored domain name 128 and corresponding domain advertising suggestion 130 immediately. If the cache 112 is missed, or in other words, if no matching domain name 128 is found in the cache 112, the DA module 110 may utilize a cache manager 158 to determine if the domain name 128 may be located in the in-memory cache 152 or in the database 114, or to send the requested domain name 128 to the AI module 116 and receive a generated domain advertising suggestion 130 for the user, to which the DA module 110 may store the generated domain advertising suggestion 130 in the cache 112. The DA module 110 may enforce automatic cache 112 invalidation based on configurable expiration rules, thus optimizing processing time and resource utilization.

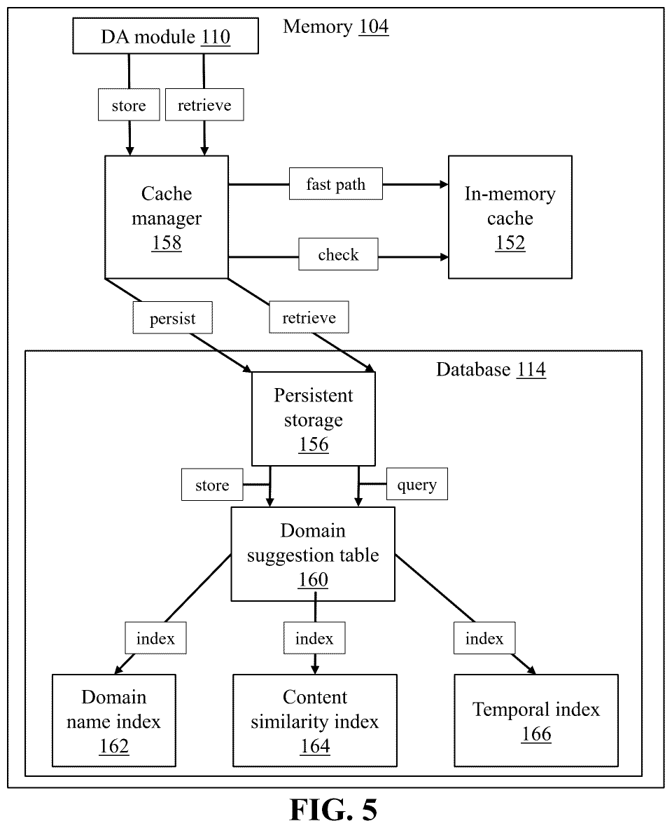

Referring now to FIG. 5, the database 114 may receive and store a domain name 128 and a domain advertising suggestion 130. For example, the database 114 may store information related to the domain name 128 and maintain historical data related to the domain name 128. The database 114 may be designed specifically for a domain advertising suggestion 130 or may store domain name 128 related information received from the DA module 110 or chatbot 108. The database 114 may interoperate with the multi-tiered caching arrangement 154 of the DA module 110 by providing a persistent storage 156 for the DA module 110 to search if the cache 112 is missed. The database 114 may also support automatic cache 112 invalidation based on configurable expiration rules.

The database 114 may include a local database 114, a database 114 saved on a remote server and accessed via a network, such as cloud server, or a combination local and remote database 114 as required by the system 100. The database 114 may include a relational database 114, for example, relational databases 114 by MySQL®, MariaDB®, PostgreSQL®, or Microsoft SQL Server®. The database 114 may, for example, include a vector database 114 to store vector embeddings. The database 114 may include time-series storage engines and graph-based knowledge representations for enhanced relationship modeling. The database 114 may store the domain name 128, domain advertising suggestion 130, and related information using a domain suggestion table 160. The domain suggestion table 160 may employ a structured schema that includes a domain name index 162, a content similarity index 164 for fuzzy matching, and a temporal index 166 for time-based queries, e.g. a time stamp. For example, the domain suggestion table 160 may include the domain name 128 as the primary key, the generated domain advertising suggestion 130, any related metadata such as a generation timestamp or model version, or performance metrics, e.g. metrics used in advertising campaigns. It should be appreciated that multiple indices ensure fast retrieval of the domain name 128 and domain advertising suggestion 130 when the database 114 is searched by the DA module 110 based on a domain name 128 request by the user.

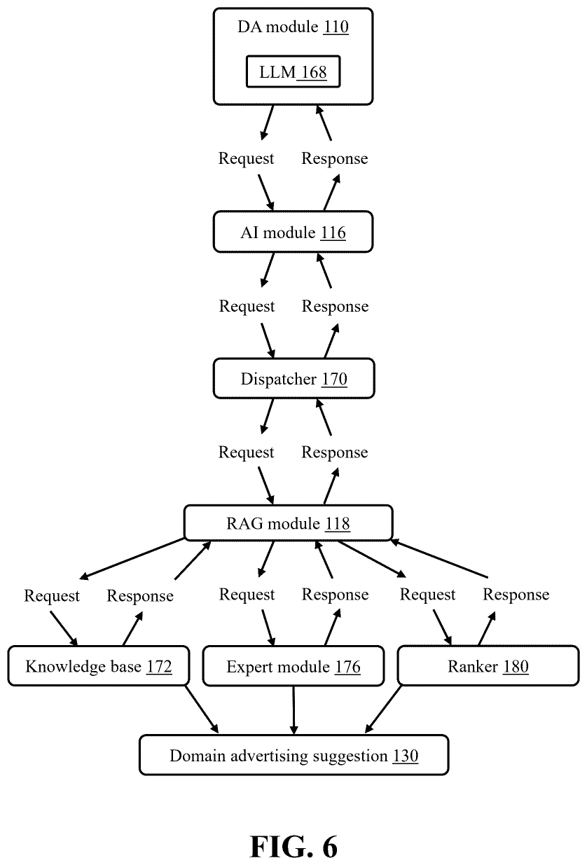

As shown in FIGS. 1 and 6, The AI module 116 may include a large language model (LLM) 168. The LLM 168 may process the domain name 128. The AI module 116 may, for example, use natural language processing (NPL) to fine-tune the LLM 168, transform a user query into a searchable format, or generate a vector embedding from a domain name 128 request from the user. The LLM 168 may be a pre-trained model (e.g., GPT-family, Claude, etc.) or a proprietary fine-tuned model for domain advertising applications. It should be understood that the AI module 116 may be periodically trained and fine-tuned with a requested domain name 128 from the user to identify a wide range of data to generate a domain advertising suggestion 130, and may optionally process and analyze the requested domain name 128 with specialized language models that may be integrated with the LLM 168, trained specifically for domain name 128 analysis and domain advertising generation. For example, the LLM 168 may integrate a specialized language model such as Namefi® GPT to analyze a requested domain name 128. It should be appreciated that integration with a specialized language model may allow for specificity in the generation of the domain advertising suggestion 130 based on the requested domain name 128. To enhance the quality of a domain advertising suggestion 130, the DA module 110 may utilize the RAG module 118 to incorporate domain name 128—specific insights and external knowledge, ensuring that the domain advertising suggestion 130 is not only specific, but tailored to and aligned with the brand messaging of a user. The AI module 116 may utilize a dispatcher 170 to send a domain name 128 to the RAG module 118, and to receive a domain advertising suggestion 130 from the RAG module 118.

The RAG module 118 may receive a domain name 128 from the LLM 168 when the domain advertising suggestion 130 is not found in the cache 112, as illustrated in FIGS. 6-8. The RAG module 118 may include a knowledge base 172 that manages connections to various knowledge source and generates a knowledge-based response 174. The RAG module 118 may include an expert module 176 that handles communication that generates an expert response 178, for example, by utilizing specialized domain models 194. The RAG module 118 may include a ranker 180 that optimizes and ranks generated knowledge-based response 174 and expert response 178. The RAG module 118 may also include reinforcement learning models, dynamic prompt construction tools, or continual learning loops. It should be understood that the RAG module 118 may manage a contextually large domain name 128 query by a user by processing the query in small portions to maintain efficiency.

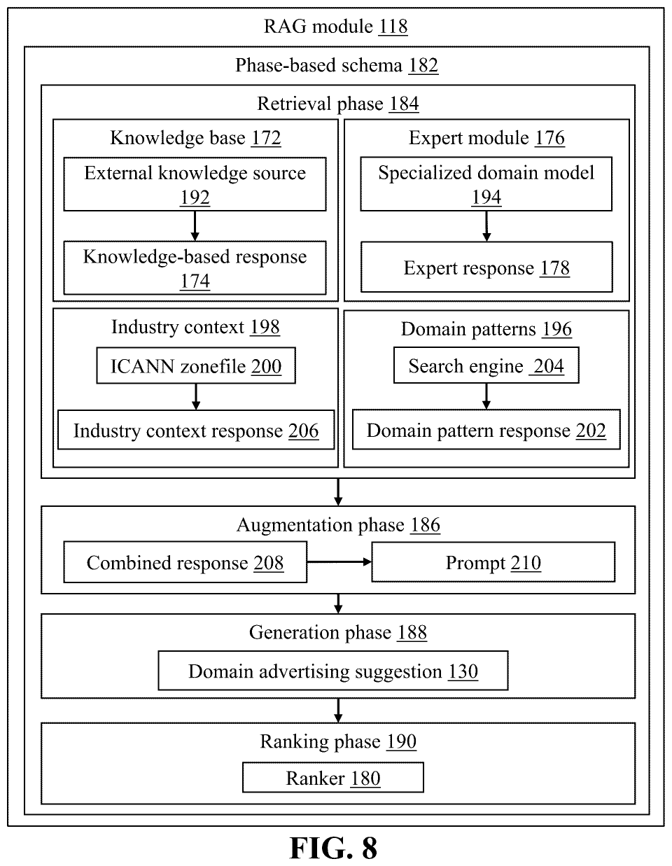

As shown in FIG. 8, aspects of the RAG module are shown. The RAG module 118 may enhance the capabilities of the LLM 168 by incorporating a phased-based schema 182, including a retrieval phase 184, an augmentation phase 186, a generation phase 188, and a ranking phase 190. The phased-based schema 182 may incorporate the knowledge base 172, expert module 176, and the ranker 180 to create a sophisticated pipeline for processing domain advertising suggestion 130 requests from the DA module 110.

During the retrieval phase 184, the RAG module 118 may query the knowledge base 172 for relevant knowledge from an external knowledge source 192 and may consult the expert module 176 for domain-specific insights from a specialized domain model 194. The RAG module 118 may retrieve a knowledge-based response 174 and an expert response 178. The RAG may further enhance the knowledge-based response 174 and the expert response 178, for example, with analysis of domain patterns 196 and industry context 198. The RAG may analyze aspects of the domain name 128 by accessing the Internet Corporation for Assigned Names and Numbers (ICANN) zonefile 200. ICANN helps coordinate the Internet Assigned Numbers Authority (IANA), a technical service that implements the underlying address book for the internet, the Domain Name System (DNS). The ICANN zonefile 200 may provide access to comprehensive information such as top-level domains, domain registration patterns, keyword popularity, related domains in the industry, industry trends, etc. The RAG may calculate metrics of similar domain names 128, top-level domain distributions, and keyword popularity, and return domain pattern response 202.

The retrieval phase 184 may include utilizing a search engine 204 to search the internet for context relating to similar industries. For example, the search engine 204 may include queries relating to businesses, industries, and competitors. The search engine 204 may interface with internet search engines such as Google, Bing, or Yahoo. The RAG module 118 may then search the ICANN zonefile 200 for the domain name 128 of any discovered businesses for further analysis. The RAG module 118 may return an industry context response 206 that includes, for example, related industries, competitors, business domains, and the analysis of each business domain discovered. It should be appreciated that the RAG module 118 may execute parallel processing of the responses, retrieving the knowledge-based response 174, the expert response 178, the domain pattern response 202, and the industry context response 206 concurrently.

During the augmentation phase 186, the RAG module 118 may combine the knowledge-based response 174, the expert response 178, the domain pattern response 202, and the industry context response 206 into a combined response 208 formatted for integration with the LLM 168. For example, the RAG module 118 may augment the combined response 208 or portions of the combined response 208 to follow a structured format, e.g. a string, array, dictionary (used in programming languages by C#, Python®, etc.), or hash or HashMap (used in programing languages by Perl®, Ruby™M, C++, Java®, Haskell®, etc.), indexing the combined response 208 into relevant topics for context, such as “similar domains found”, “popular top- level domains”, “keyword popularity”, “domain pattern insights”, and the like. The RAG may also format a portion of the industry context response 206, for example, into relevant topics such as “related industries”, “potential competitors”, “industry patterns”, and the like.

During the generation phase 188, the RAG module 118 may generate a prompt 210 that incorporates the combined response 208. For example, the prompt 210 may include the domain name 128, the combined response 208 including industry alignment based on the analysis of the domain patterns 196, competitive positioning against similar businesses, relevance to common use cases for similar domain names 128, and the distinctive value of the domain name 128 compared to relevant industry standards. The prompt 210 may be provided the AI module 116 to generate one or more domain advertising suggestions 130.

During the ranking phase 190, the RAG module 118 may utilize the ranker 180 to rank the one or more domain advertising suggestions 130. The ranker 180 may refine a top domain advertising suggestion 130 that will be provided to the user or to a communication channel 132. As shown in FIGS. 1-2 and 7A-8, the ranker 180 may receive and rearrange the one or more domain advertising suggestions 130 based on the relevance and quality of the domain advertising suggestion 130 to the requested domain name 128. It should be appreciated that the ranker 180 may enhance the quality of the generated domain advertising suggestion 130 by the RAG module 118, ensuring that RAG module 118 utilizes the most pertinent information retrieved in relation to the domain name 128 request of the user. Once the ranker 180 ranks and refines the one or more domain advertising suggestions 130, the RAG module 118 may provide the top domain advertising suggestion 130 to the dispatcher 170, the dispatcher 170 relaying the domain advertising suggestion 130 to the DA module 110 for storing in the cache 112 or database 114.

It should be appreciated that the RAG module 118 may generate a domain advertising suggestion 130 with deeper market awareness, stronger brand positioning, and more accurate value propositions tailored to the potential commercial applications and worth of the domain name 128. The RAG module 118 may enhance the domain market intelligence capabilities of the system 100, e.g. incorporating real-time stock market data historical financial data to align advertising suggestions with market trends and company valuations, brand databases including registry information to identify established brands, and comprehensive brand value analysis including trademark considerations. The RAG module 118 may, for example, expand advertising distribution through aggregated data from multiple domain sales platforms and marketplaces such as platforms by Sedo® and dan.com, search engine 204 advertising, AI-driven personalization outreach and targeted email outreach, and social media management platforms by LinkedIn® B2B promotions with company size and industry filtering, Facebook® entrepreneurial and branding groups, or Reddit® submissions to r/Domains, r/Entrepreneur, and vertical-specific subreddits. The RAG module 118 may also provide, for example, automated listing and bump scheduling on NamePros.com@ or other domain forums. For example, the RAG module 118 may include data from domain news and marketplace platforms, e.g. domain platforms by DNJournal@, GoDaddy® Auctions, Afternic®, BrandBucket®, and Atom® (formerly Squadhelp®), comparing pricing trends across different domain categories and top-level domains. The RAG module 118 may, for example, retrieve keyword and search volume metrics from marketing analytics platforms by Google® Keyword Planner, SEMrush®, and Ahrefs®. In another example, the RAG module 118 may provide competition and comparative metrics including Cost-Per-Click (CPC) data, industry scoring, startup and product naming trends, geographic appropriateness, top-level domain values, temporal popularity trends from Google Trends™ search engine optimization tool, and domain length and memorability scoring.

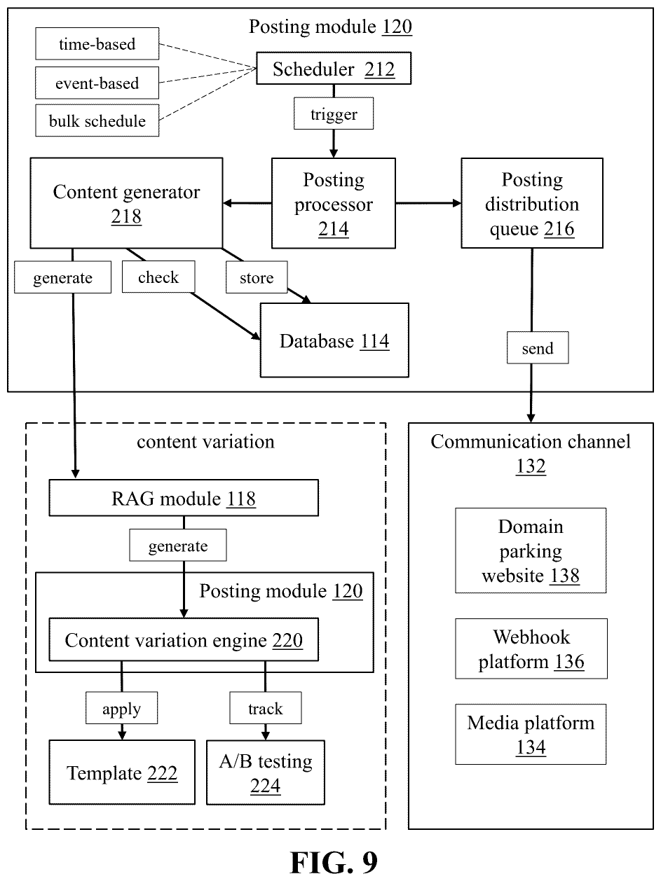

Referring now to FIG. 9, the posting module 120 may post the domain advertising suggestion 130 to a communication channel 132, such as a domain parking website 138. The posting module 120 may include a scheduler 212 for posting the domain advertising suggestion 130. For example, the scheduler 212 may be time-based, e.g. daily, weekly, etc., event-based, e.g. the scheduler 212 is triggered during a domain acquisition or renewal, or may be bulk scheduled, e.g. high-volume operations. The scheduler 212 may trigger a posting processor 214 to either provide an existing domain advertising suggestion 130 to a posting distribution queue 216 that will post the domain advertising suggestion 130 on a communication channel 132 or initiate a content generator 218 to initiate the generation of a new domain advertising suggestion 130. The posting module 120 may include a content variation engine 220 to enhance the variety in a generated domain advertising suggestion 130. The content variation engine 220 may utilize a template 222 stored in the database 114, and may include A/B testing 224 capabilities, e.g. comparing the performance of two domain advertising suggestions 130 to see which one appeals more to visitors on the domain parking website 138. The posting module 120 may dynamically schedule content based on audience activity, A/B test 224 results, or multi-platform feedback loops.

The posting module 120 may control how a domain advertising suggestion 130 is distributed, for example, executing rate limitations to help militate against platform restrictions, detecting optimal timing for posts, and tracking the performance of a post. It should be understood that the posting module 120 may initiate the generation of a new domain advertising suggestion 130 through the normal executional process of the system 100, e.g. the content generator 218 may send a request to the DA module 110 for generating the domain advertising suggestion 130, which is sent to the LLM 168, the LLM 168 to the dispatcher 170, and the dispatcher 170 to the RAG module 118, etc. Additionally, the posting module 120 may communicate with the chatbot 108 for notifications of which communication channel 132 to post the domain advertising suggestion 130.

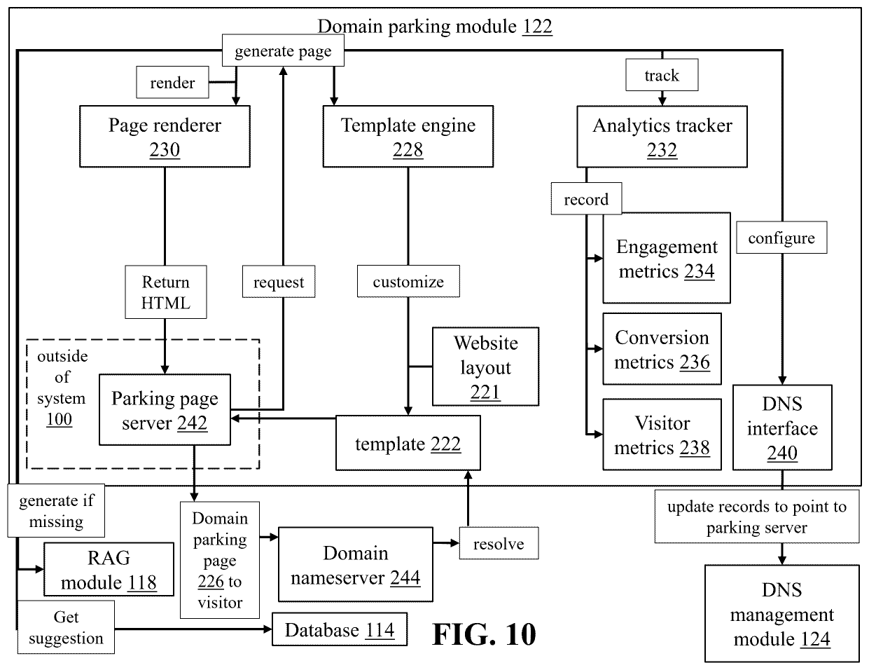

As shown in FIG. 10, the domain parking module 122 may enable the use of an existing or generated domain advertising suggestion 130 on a domain parking page 226. The domain parking module 122 may include a template engine 228 to manage the layout and design of a domain parking page 226. The template engine 228 may utilize a responsive template 222 for the domain parking page 226. For example, the template engine 228 may determine the optimal positioning of the domain advertising suggestion 130, headline and description placement, and position of the call-to-action. The domain parking module 122 may include a page renderer 230 that may render a domain parking page 226 on a domain parking website 138. The domain parking module 122 may include an analytics tracker 232 to track the metrics of the domain name 128, e.g. via a tracking ID, including engagement metrics 234, conversion metrics 236, and visitor metrics 238. The domain parking module 122 may include a DNS interface 240 in order to update records to point the parking page server 242. For example, the DNS interface 240 may redirect configurations and configure split testing setup. This ensures that visitors to the domain name 128 are directed to the domain parking page 226 that displays the generated domain advertising suggestion 130. The domain parking module 122 may configure a domain nameserver 244 if needed prior to rendering the domain advertising suggestion 130 domain parking page 226.

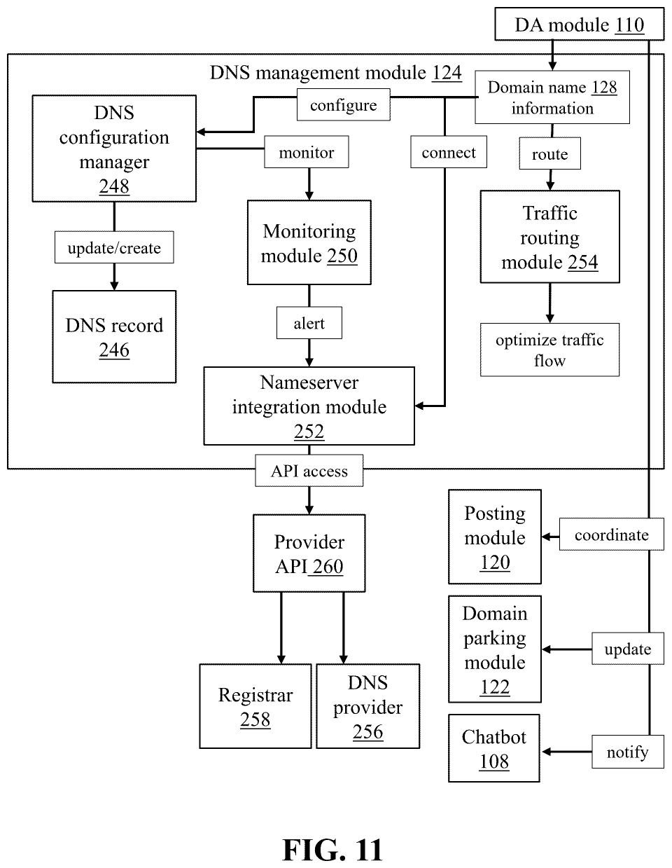

As shown in FIG. 11, the DNS management module 124 may manage a domain nameserver 244 and a DNS record 246 to ensure proper domain configuration, for example, in the use of advertising campaigns and automate the configuration and optimization of domain name 128 settings. For example, the DNS management module 124 may allow for time-to-live optimization, and domain name system security extensions (DNSSEC) configurations. The DNS management module 124 may include a DNS configuration manager 248, a monitoring module 250, a nameserver integration module 252, and a traffic routing module 254. The DNS configuration manager 248 may execute the creation and modification of different types of DNS records 246, such as an address (A) record, a quad A (AAAA) record, a canonical name (CNAME), text format (TXT) record, and a mail exchange (MX) record. The DNS configuration manager 248 may also monitor the nameserver integration module 252 via the monitoring module 250 to alert the nameserver integration module 252 when to access a DNS provider 256 or registrar 258. The nameserver integration module 252 may provide API access via a provider API 260 to a registrar 258 or a DNS provider 256. The traffic routing module 254 may optimize traffic flow for the DNS management module 124 such as geographic routing, load balancing, A/B testing 224 support, and analytics integration. It should be appreciated that the DNS management module 124 may allow for rapid deployment of a domain parking page 226, redirection, or other advertising-related configurations. For example, the DNS management module 124 may determine the DNS provider 256 from the registration data of the domain name 128, receive a base template 222, and merge with custom records of the domain name 128 if provided, or apply DNS record 246 changes and set up monitoring via the monitoring module 250.

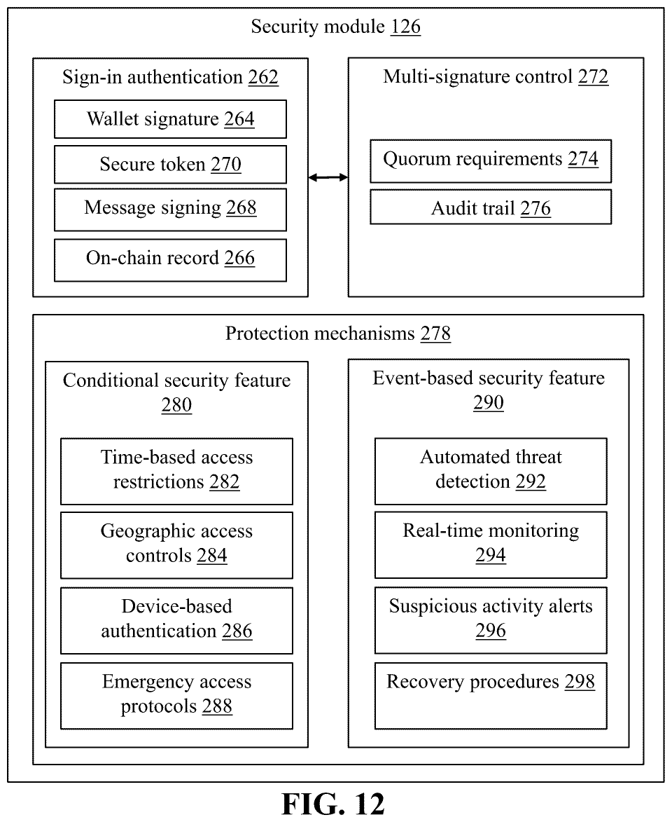

The memory 104 may also include a security module 126 to provide enhanced protection of domain name 128 management, as shown in FIG. 12. For example, the security module 126 may include sign-in authentication 262 such as the Sign-In-With-Ethereum® (SIWE) authentication standard where the security module 126 may employ decentralized identity verification such as a wallet signature 264, provide enhanced protection through role-based access control (RBAC) tied to wallet addresses, verify domain ownership through an on-chain record 266, authenticate non-custodial access with message signing 268, or manage sessions with the generation of a secure token 270. The security module 126 may also allow for multi-signature control 272, for example, with Gnosis SAFE™ multi-signature to allow for configurable quorum requirements 274 or provide an audit trail 276 of all multi-signature operations. The security module 126 may also incorporate biometric authentication (e.g., facial, fingerprint), integration with decentralized identifiers (DIDs), or WebAuthn protocol compatibility.

The security module 126 may host one or more protection mechanisms 278, including a conditional security feature 280. The conditional security feature 280 may allow for restrictions such as time-based access restrictions 282, geographic access controls 284, device-based authentication 286, or emergency access protocols 288. The protection mechanisms 278 may also include an event-based security feature 290. The event-based security feature 290 may allow for the system 100 to trigger security measures such as automated threat detection 292 and response, real-time monitoring 294 of access patterns, and suspicious activity alerts 296 that trigger an automated account lockout. The event-based security feature 290 may provide recovery procedures 298 for lost access to a domain transaction. The security module 126 may allow the system 100 to comply with data privacy frameworks such as the EU general data protection regulation (GDPR) or California Consumer Privacy Act (CCPA) and include user opt-in/opt-out management for tracked analytics.

As shown in FIGS. 13A and 13B, a method 300 for generating a domain advertising suggestion 130 to a user based on a domain name 128 is provided. The method 300 may include a step 302 of providing a processor 102, and a memory 104 in communication with the processor 102. The memory 104 may include a user interface module 106, a domain advertising (DA) module, an artificial intelligence (AI) module, and a cache 112. The user interface module 106 may receive the domain name 128 from the user. The DA module 110 may receive the domain name 128 from the user interface module 106. The DA module 110 may search the cache 112 for the domain name 128 and the domain advertising suggestion 130 based on the domain name 128. The DA module 110 may provide the user interface module 106 the domain advertising suggestion 130 based on the domain name 128 when the cache 112 includes the domain name 128. The AI module 116 may receive the domain name 128 from the DA module 110 and generate the domain advertising suggestion 130 based on the domain name 128. The AI module 116 may provide the domain advertising suggestion 130 to the DA module 110. The cache 112 may receive the domain name 128 from the user interface module 106 and store the domain name 128. The cache 112 may receive and store the domain advertising suggestion 130 when generated by the AI module 116. The DA module 110 may provide the user interface module 106 the domain advertising suggestion 130 based on the domain name 128 when generated by the AI module 116.

The method 300 may include a step 304 of receiving the domain name 128 from the user via the user interface module 106. The method 300 may include a step 306 of receiving the domain name 128 from the user interface module 106 and storing the domain name 128 in the cache 112. The method 300 may include a step 308 of searching the cache 112 for the domain name 128 and the domain advertising suggestion 130. The method 300 may include a step 310 of providing the user with the domain advertising suggestion 130 based on the domain name 128 when the cache 112 includes the domain name 128. The method 300 may include a step 312 of generating a domain advertising suggestion 130 via the AI module 116 when the cache 112 does not include the domain name 128, thereby producing a generated domain advertising suggestion 130, the generated domain advertising suggestion 130 based on the domain name 128. The method 300 may include a step 314 of providing the user the generated domain advertising suggestion 130 via the user interface module 106 when the cache 112 does not include the domain name 128. The method 300 may include a step 316 of storing the domain name 128 and the generated suggestion in the cache 112.

As shown in FIG. 14, a method 400 for generating a domain advertising suggestion 130 to a user based on a domain name 128 is provided. The method 400 may include steps 302-312 of method 300 (as steps 402-412 respectively). The method 400 may include a step 414 of providing in the AI module 116 a large language model (LLM 168), a retrieval-augmented generation (RAG) module 118. The LLM 168 may process the domain name 128 for the RAG module 118. The RAG module 118 may include a knowledge base 172, an expert module 176, and a ranker 180. The knowledge base 172 may retrieve a knowledge-based response 174 from an external knowledge source 192. The expert module 176 may retrieve an expert response 178 from a specialized domain model 194. The ranker 180 may receive and rank the knowledge-based response 174 and the expert response 178. The method 400 may include a step 416 of processing the domain name 128 via the LLM 168, producing a processed domain. The method may include a step 418 of receiving the processed domain name 128 via the RAG module 118. The method may include a step 420 of retrieving a knowledge-based response 174 from an external knowledge source 192. The method may include a step 422 of retrieving an expert response 178 from a specialized domain model 194. The method may include a step 424 of receiving the knowledge-based response 174 and the expert response 178 via the ranker 180. The method may include a step 426 of ranking the knowledge-based response 174 and the expert response 178 via the ranker 180. The method 400 may include steps 314-316 of method 300 (as steps 428-430 respectively).

As shown in FIG. 15, a method 500 for generating a domain advertising suggestion 130 to a user based on a domain name 128 is provided. The method 500 may include steps 302-316 of method 300 (as steps 502-516 respectively). The method 500 may include a step 518 of providing in the memory 104 a posting module 120 and a domain parking module 122. The posting module 120 may schedule a post including the domain advertising suggestion 130 to a communication channel 132 or a domain parking website 138. The domain parking module 122 may render a website layout 221. The method 500 may include a step 520 of scheduling a post to a communication channel 132 via the posting module 120, the post including the domain advertising suggestion 130. The method 500 may include a step 522 of rendering a website layout 221 via the domain parking module 122. The method 500 may include a step 524 of posting the domain advertising suggestion 130 to a domain parking website 138 via the posting module 120 using the website layout 221.

As shown in FIG. 16, a method 600 for generating a domain advertising suggestion 130 to a user based on a domain name 128 is provided. The method 600 may include steps 302-316 of method 300 (as steps 602-616 respectively). The method 600 may include a step 618 of providing in the memory 104 a database 114. The method may include a step 620 of storing the domain advertising suggestion 130 in the database 114.

As shown in FIG. 17, a method 700 for generating a domain advertising suggestion 130 to a user based on a domain name 128 is provided. The method 700 may include steps 302-316 of method 300 (as steps 702-716 respectively). The method 700 may include a step 718 of providing in the user interface module 106 a chatbot 108. The chatbot 108 may communicate with the AI module 116. The chatbot 108 may provide the domain advertising suggestion 130 to a communication channel 132. The method 700 may include a step 720 of providing the domain advertising suggestion 130 to a communication channel 132 via the chatbot 108.

As shown in FIG. 18, a method 800 for generating a domain advertising suggestion 130 to a user based on a domain name 128 is provided. The method 800 may include steps 302-316 of method 300 (as steps 802-816 respectively). The method 800 may include a step 818 of providing in the user interface module 106 a security module 126. The security module 126 may verify the user via a wallet signature 264. The method 820 may include a step of verifying the user via the security module 126 by requiring the user to execute a wallet signature 264.

Advantageously, the present technology may provide an automated solution to the challenges identified in other domain name advertising and marketing methods. By utilizing artificial intelligence, specifically language models combined with retrieval-augmented generation techniques, the system 100 may effectively automate the generation of a domain advertising suggestion 130, reducing the need for manual input and overcoming inefficiencies and inconsistencies associated with manual processes. The advanced multi-tiered caching arrangement 154 may enhance operational efficiency, while the chatbot 108 may afford continuous integration across various communication channels 132, addressing the limitations of other systems 100 regarding integration capabilities. Furthermore, the incorporation of domain-specific insights and external knowledge from the knowledge base 172 and expert module 176 may ensure customized and strategically aligned content, thereby augmenting the marketing effectiveness otherwise hindered by generic content. This approach may address the inefficiencies of other methods and may offer a scalable, reliable, and effective advertising solution within the domain advertising sphere.

### EXAMPLES

Example embodiments of the present technology are provided with reference to the several figures including FIGS. 1-18 enclosed herewith.

### Example 1: Automated Creation of Contextually Relevant Domain Advertising

In this scenario, a user accesses the system 100 via a user interface module 106 to generate a domain advertising suggestion 130 for a newly acquired domain name 128. Upon entering the domain name 128 into the platform, the DA module 110 receives the input and processes the domain name 128 request. The AI module 116 may receive the domain name 128 to create an initial domain advertising suggestion 130. Alternatively, the RAG module 118 may receive the domain name 128 from the AI module 116 to create a customized domain advertising suggestion 130 by consulting domain-specific insights and external knowledge sources 192 through the knowledge base 172, and receiving expert-level insights such as market trends, linguistic patterns, and domain semantics, retrieved from the expert module 176, as shown in FIGS. 6 and 8. Once the domain advertising suggestion 130 is generated, the cache 112 may store the result and check for previous similar entries to enhance processing efficiency. The ranker 180 of the RAG module 118 may rank each domain advertising suggestion 130 for the top entry, where the system 100 delivers the top domain advertising suggestion 130 to the user via the user interface module 106, readying the domain advertising suggestion 130 for distribution across selected communication channels 132 via the chatbot 108.

### Example 2: Domain Parking Optimization

A domain investor uses the system 100 to enhance the attractiveness of a domain parking page 226 by utilizing targeted domain advertising suggestions 130. The DNS management module 124 configures the necessary DNS record 246 settings for the domain name 128 in question, ensuring it directs visitors to the appropriate domain parking page 226. By integrating the retrieval-augmented generation features of the RAG module 118 and gathering external data insights and knowledge sources with the knowledge base 172 and expert module 176, the system 100 may generate customized domain advertising suggestions 130 that may include tailored headlines, calls to action, and relevant descriptions. Such content generated by the RAG module 118 improves the likelihood of engagement from potential buyers or audiences exploring the domain parking page 226. Additionally, the chatbot 108 may facilitate strategic dissemination via social media platforms 134 and other advertising forums such as a webhook platform 136, as shown in FIG. 3, making the offer for the domain name 128 visible to a targeted audience and increasing potential interest in the parked domain.

### Example 3: Multi-Channel Advertising Campaign Coordination

A marketing manager for a domain portfolio employs the system 100 to execute a coordinated advertising campaign across multiple digital platforms. After the user inputs domain names 128 to the user interface module 106, the DA module 110, together with the AI module 116 and the RAG module 118, crafts individual domain advertising suggestions 130 for each domain name 128, incorporating detailed insights from the integrated expert module 176 and external knowledge sources 192 from the knowledge base 172. Through the phased-based schema 182 of the RAG module 118, these domain advertising suggestions 130 are formatted and adapted for various platforms and posted to the platforms via the chatbot 108. The chatbot 108 may employ adaptations specific to the character limits and media formats for social networks, team collaboration tools, and custom web interfaces. As shown in FIG. 10, the domain parking module 122 may track the campaign performance, including engagement metrics 234, conversion metrics 236, and visitor metrics 238, allowing the marketing manager to refine strategies through real-time data and achieve greater impact with minimal manual intervention.

### Example 4: Customized Domain Parking Generation and User Purchase

A company uses the system 100 to generate a domain parking page 226 for “tractorsrus.com”, by utilizing targeted domain advertising suggestions 130. The company utilizes the RAG module 118 to gather external data insights and knowledge sources with the knowledge base 172 and expert module 176 to generate customized domain advertising suggestions 130 that may include customized headlines for construction and farm equipment, contextually applicable descriptions for construction and farm equipment marketplace analytics, and a call to action. The domain parking module 122 may generate the domain parking page 226 with a template engine 228 to manage the layout and design of a domain parking page 226, determining the optimal positioning of the domain advertising suggestion 130, headline and description placement, and position of the call-to-action. The domain parking module 122 then renders the domain parking page 226 on a domain parking website 138.

The tailored domain parking page 226 attracts the interest of a potential buyer that visits the domain parking page 226. The buyer views the headline and the description of the domain advertising suggestion 130, is enticed by the relevant content and proceeds to buy the domain. Once the transaction is complete, the buyer may utilize the domain name 128 to direct the customers of the buyer to an agricultural machinery manufacturing business website associated with the domain name 128. Customers of the buyer may now view the domain in association with the business in order to buy or finance agricultural machinery, buy parts, or schedule maintenance services.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A system for generating a domain advertising suggestion to a user based on a domain name, comprising:
a processor;
a memory in communication with the processor, the memory including a user interface module, a domain advertising (DA) module, an artificial intelligence (AI) module, and a cache,
wherein:
the user interface module is configured to receive the domain name from the user;
the DA module is configured to receive the domain name from the user interface module, search the cache for the domain name and the domain advertising suggestion based on the domain name, and provide the user interface module the domain advertising suggestion based on the domain name when the cache includes the domain name;
the AI module is configured to receive the domain name from the DA module, generate the domain advertising suggestion based on the domain name, and provide the domain advertising suggestion to the DA module;
the cache is configured to receive the domain name from the user interface module, store the domain name, and receive and store the domain advertising suggestion when generated by the AI module; and
the DA module is further configured to provide the user interface module the domain advertising suggestion based on the domain name when generated by the AI module.

2. The system of claim 1, wherein the user interface module includes a chatbot in communication with the AI module, the chatbot configured to provide the domain advertising suggestion to a communication channel.

3. The system of claim 1, wherein the user interface module includes a security module configured to verify the user via a wallet signature.

4. The system of claim 1, wherein the AI module includes a large language model (LLM).

5. The system of claim 1, wherein the AI module includes a retrieval-augmented generation (RAG module) module, the RAG module including a knowledge base and an expert module, wherein the knowledge base is configured to retrieve a knowledge-based response from an external knowledge source, and the expert module is configured to retrieve an expert response from a specialized domain model.

6. The system of claim 5, wherein the RAG module further includes a ranker configured to receive and rank the knowledge-based response and the expert response.

7. The system of claim 1, wherein the memory further includes a database configured to store the domain advertising suggestion.

8. The system of claim 1, wherein the memory further includes a posting module configured to post the domain advertising suggestion to a communication channel.

9. The system of claim 8, wherein the posting module is further configured to post the domain advertising suggestion to a domain parking website.

10. The system of claim 9, wherein the memory further includes a domain parking module configured to render a website layout, and the posting module is further configured to post the domain advertising suggestion to a domain parking website using the website layout.

11. A method for generating a domain advertising suggestion to a user based on a domain name, comprising:
providing a processor, a memory in communication with the processor, the memory including a user interface module, a domain advertising (DA) module, an artificial intelligence (AI) module, and a cache,
wherein:
the user interface module is configured to receive the domain name from the user,
the DA module is configured to receive the domain name from the user interface module, search the cache for the domain name and the domain advertising suggestion based on the domain name, and provide the user interface module the domain advertising suggestion based on the domain name when the cache includes the domain name,
the AI module is configured to receive the domain name from the DA module, generate the domain advertising suggestion based on the domain name, and provide the domain advertising suggestion to the DA module,
the cache is configured to receive the domain name from the user interface module, store the domain name, and receive and store the domain advertising suggestion when generated by the AI module, and
the DA module is further configured to provide the user interface module the domain advertising suggestion based on the domain name when generated by the AI module;
receiving the domain name from the user via the user interface module;
receiving the domain name from the user interface module and storing the domain name in the cache;
searching the cache for the domain name and the domain advertising suggestion;
providing the user with the domain advertising suggestion based on the domain name when the cache includes the domain name;
generating a domain advertising suggestion via the AI module when the cache does not include the domain name, thereby producing a generated suggestion, the generated suggestion based on the domain name;
providing the user the generated suggestion via the user interface module when the cache does not include the domain name; and
storing the domain name and the generated suggestion in the cache.

12. The method of claim 11, wherein the user interface module includes a chatbot in communication with the AI module, the chatbot configured to provide the domain advertising suggestion to a communication channel.

13. The method of claim 11, wherein the user interface module includes a security module configured to verify the user via a wallet signature.

14. The method of claim 11, wherein the AI module includes a large language model (LLM).

15. The method of claim 11, wherein the AI module includes a retrieval-augmented generation (RAG) module, the RAG module including a knowledge base and an expert module, wherein the knowledge base is configured to retrieve a knowledge-based response from an external knowledge source, and the expert module is configured to retrieve an expert response from a specialized domain model.

16. The method of claim 15, wherein the RAG module further includes a ranker configured to receive and rank the knowledge-based response and the expert response.

17. The method of claim 11, wherein the memory further includes a database configured to store the domain advertising suggestion.

18. The method of claim 11, wherein the memory further includes a posting module configured to post including the domain advertising suggestion to a communication channel.

19. The method of claim 18, wherein the posting module is further configured to post the domain advertising suggestion to a domain parking website.

20. The method of claim 19, wherein the memory further includes a domain parking module configured to render a website layout, and the posting module is further configured to post the domain advertising suggestion to a domain parking website using the website layout.
